(19) United States
(12) Patent Application Publication
(10) Pub. No.: US 2017/0051776 A1
(43) Pub. Date: Feb. 23, 2017

(54) Magnetic Plug for Internal Drive Fitting

(71) Applicant: CATERPILLAR INC., Peoria, IL (US)

(72) Inventors: Craig D. Samuelson, Dunlap, IL (US); Nathan Bjerke, Peoria, IL (US); Thomas M. Congdon, Dunlap, IL (US)

(73) Assignee: CATERPILLAR INC., Peoria, IL (US)

(21) Appl. No.: 14/831,290

(22) Filed: Aug. 20, 2015

(51) Int. Cl. F16B 33/00; E02F 3/04; F16B 23/00; E02F 9/00

(52) U.S. Cl. CPC F16B 33/004; E02F 9/00; E02F 3/04; F16B 23/0007

(57) ABSTRACT

A plug is disclosed for excluding foreign material from the drive socket of a driven element including a plug body having top, bottom, and a plurality of side portions extending between the top and bottom portions. The plug body is sized and shaped to be received within the drive socket. A magnet is disposed in the plug body. A plurality of ribs is disposed on the plurality of side portions of the plug body, the ribs sized and shaped to be removably received in the drive socket and exclude the intrusion of foreign material into the drive socket and at least one removal feature is formed at or near the top portion.

### TECHNICAL FIELD

This disclosure relates generally to a removable magnetic plug for a driven element such as a fastener with a square drive. The magnetic plug is received within and occupies a socket of the driven element and functions to exclude foreign material such as dirt from the socket.

### BACKGROUND

One challenge of operating machinery in outside environments is that the presence of foreign material and debris such as soil and rock, that is on or is deposited in the machinery, can interfere with the operation, adjustment, repair and/or maintenance of the machinery. Machines such as earth working machinery are provided with fasteners and other driven elements that are engaged with tools to lock, capture, remove, tighten and/or otherwise adjust the fasteners, adjuster mechanisms, locking nuts or other elements and mechanisms.

One such family of driven elements is engaged and operated with an internally fitting tool such as a torque wrench with a square drive. Other driven elements are engaged with other species of internally fitting tools such as a hex drive screwdriver tool. There are a number of internally fitting drive tools and corresponding driven elements contemplated by the disclosure. When sockets of the driven elements, which can be in the form of a square drive or a hexagonal drive, for example, are filled or packed with dirt, rocks or other foreign material, it can become difficult to insert a tool into the drive socket and positively engage and operate the element.

One example of driven elements illustrates the challenge. Many ground and earth working machines such as excavators, bulldozers, bucket loaders and the like have ground-engaging tools. The ground engaging tools are made to be replaceable because they engage soil and rock and can wear out in use. Many such tools are held in place on the machine by a retaining pin, which itself can be held in place with various mechanisms. One such mechanism is made by Caterpillar Inc. and includes a metal locking mechanism for attaching ground engaging tools to earth moving, excavation, and mining machines, for example. The mechanism includes a modified captive locknut attached to the tool part that engages a retaining pin in one orientation and, when rotated, disengages the retaining pin in another orientation to permit the replaceable ground-engaging tool to be removed from the retaining pin and thus the machine. Such a modified captive locknut is shown in FIG. 1 and detailed herein and will be understood to be one example of a driven element. Some other examples of driven elements are fasteners, screws, bolts, magnetic plugs, freeze plugs, threaded inserts and the like that include a female socket that receives and engages a correspondingly shaped and sized male tool to rotate, insert or otherwise manipulate the driven element. It should be appreciated that the sockets of such modified locknuts and other driven elements can become fouled or packed with foreign material, which can prevent or at least hinder insertion of an appropriate drive tool.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a plug for excluding foreign material from the drive socket of a driven element including a plug body having top, bottom, and a plurality of side portions extending between the top and bottom portions. The plug body is sized and shaped to be received within the drive socket. A magnet is disposed in the plug body. A plurality of ribs is disposed on the plurality of side portions of the plug body, the ribs sized and shaped to be removably received in the drive socket and exclude the intrusion of foreign material into the drive socket and at least one removal feature is formed at or near the top portion.

In another embodiment, the present disclosure describes a tool assembly removably mountable to a machine, including a replaceable ground-engaging tool. A driven element is provided for removably securing the ground-engaging tool to the machine. The driven element includes a drive socket and a plug is disposed in the drive socket of the driven element. The plug includes a plug body having top, bottom, and a plurality of side portions extending between the top and bottom portions. The plug body is sized and shaped to be received within the drive socket. A magnet is disposed in the plug body. A plurality of ribs is disposed on the plurality of side portions of the plug body, the ribs sized and shaped to be removably received in the drive socket and exclude the intrusion of foreign material into the drive socket and at least one removal feature is formed at or near the top portion.

In yet another embodiment, the present disclosure describes a method of mitigating packing of foreign material in a drive socket of a driven element, including providing the drive socket in a selected size and shape, providing a plug with a size and shape to conform to the selected size and shape of the drive socket, removably fitting the plug in the drive socket and retaining the plug in the drive socket magnetically and via a friction fit.

Further and alternative aspects and features of the disclosed principles will be appreciated from the following detailed description and the accompanying drawings. As will be appreciated, the principles related to end cutting-bits disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a side view of an example of a driven element for use with devices according to the disclosure having a square drive socket.

FIG. 2 is a cross section view of an embodiment of a plug constructed in accordance with the principles of the present disclosure and shown installed in the driven element of FIG. 1.

FIG. 3 is a top view of the plug of FIG. 2 shown installed in the driven element of FIG. 1.

FIG. 4 is a side view of the plug of FIG. 2.

FIG. 5 is a cross section view of the plug of FIG. 2.

FIG. 6 is a top view of the plug of FIG. 2.

FIG. 7 is a bottom view of the plug of FIG. 2.

FIG. 8 is a perspective view of the plug of FIG. 2.

FIG. 9 is a cross section view of another embodiment of a plug constructed in accordance with the principles of the present disclosure and shown installed in a driven element.

FIG. 10 is a side view of the plug of FIG. 9.

FIG. 11 a cross section view of the plug of FIG. 9.

FIG. 12 is a top view of the plug of FIG. 9.

FIG. 13 is a bottom view of the plug of FIG. 9.

FIG. 14 is a perspective view of the plug of FIG. 9.

FIG. 15 is a perspective view of yet another embodiment of a plug constructed in accordance with the principles of the present disclosure.

FIGS. 16 and 17 are a perspective view and a side view of a replaceable ground-engaging tool with a driven element and plug in position in accordance with the principles of the present disclosure.

FIG. 18 is a diagrammatic side elevation view of an embodiment of a machine including an embodiment of a plug constructed in accordance with principles of the present disclosure.

### DETAILED DESCRIPTION

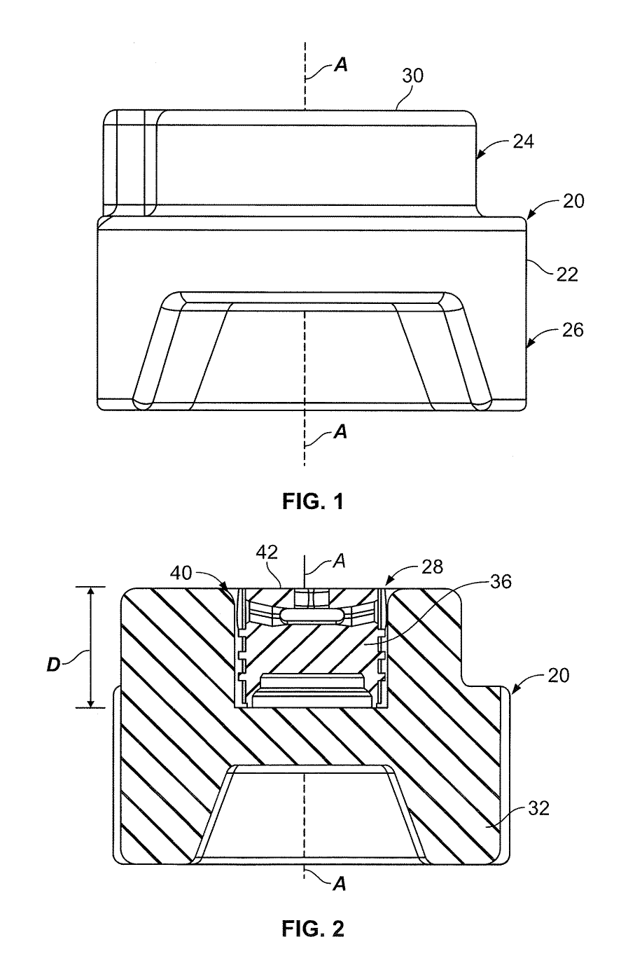

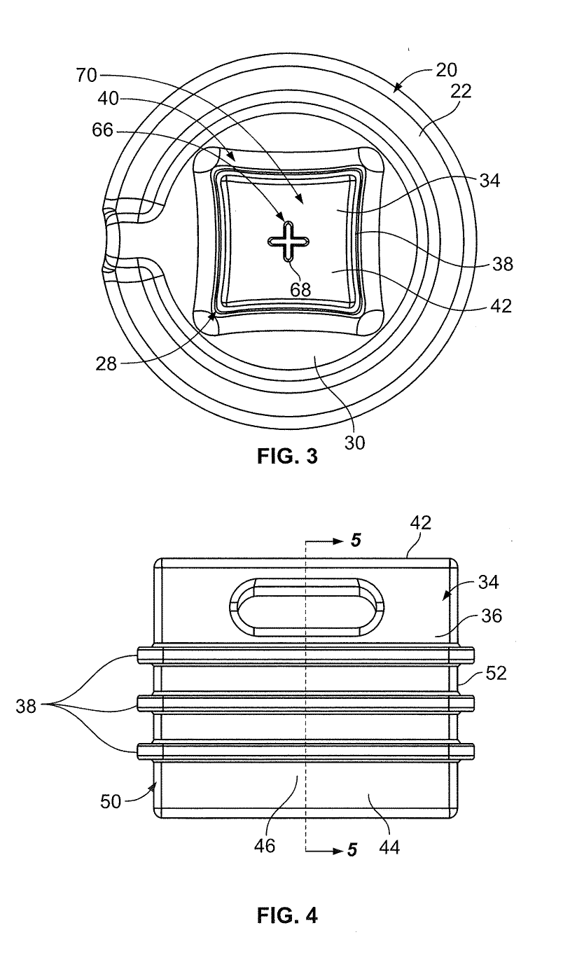

This disclosure relates to a removable magnetic plug for use in combination with a driven element. For context, an example of a driven element is shown in FIGS. 1 and 2, wherein the driven element 20, which is a type of rotatable locking element, includes a body 22, which can be made of metal, such as cast iron or steel. The body 22 may generally include an upper portion 24 and a lower portion 26. The body 22 may also have an axis A. The upper portion 24 includes a socket 28 formed therein, which is longitudinally aligned to axis A, and opens to the top 30 of the body. A bevel or radius 40 may be formed where the socket 28 opens to the top 30.

Generally, the body may be rounded about axis, A. The lower portion 26 includes a partially enclosed skirt or arcuate wall 32. Viewed as depicted in the figures, the arcuate wall 32 is open to the front and closed on the backside thereof. Therefore, an end of a well-known retaining pin (not shown) can be received from the open front side but is trapped or retained by the closed backside of arcuate wall 32.

Other examples of driven elements include, but are not limited to screws, bolts, freeze plugs, magnetic plugs, fasteners, adjusters and the like, all of which will include some sort of tool-receiving socket or feature. Examples of drive tools that may be used with driven elements such as those discussed herein are a square drive screwdriver, a hex wrench, a Torx® wrench, a square drive sliding tee bar, a square drive bit, a drive ratchet, a key square drive, a ratchet wrench, an impact wrench, a hydraulic torque tool, and a torque wrench (not shown).

The size and shape of the socket 28 may be prescribed by a standard, such as according to an ASTM standard, but for purposes of this application, may be considered to be generally square with a depth, D, that permits sufficient engagement with a corresponding square drive tool (not shown). It will be understood that other configurations of the socket are contemplated by this disclosure.

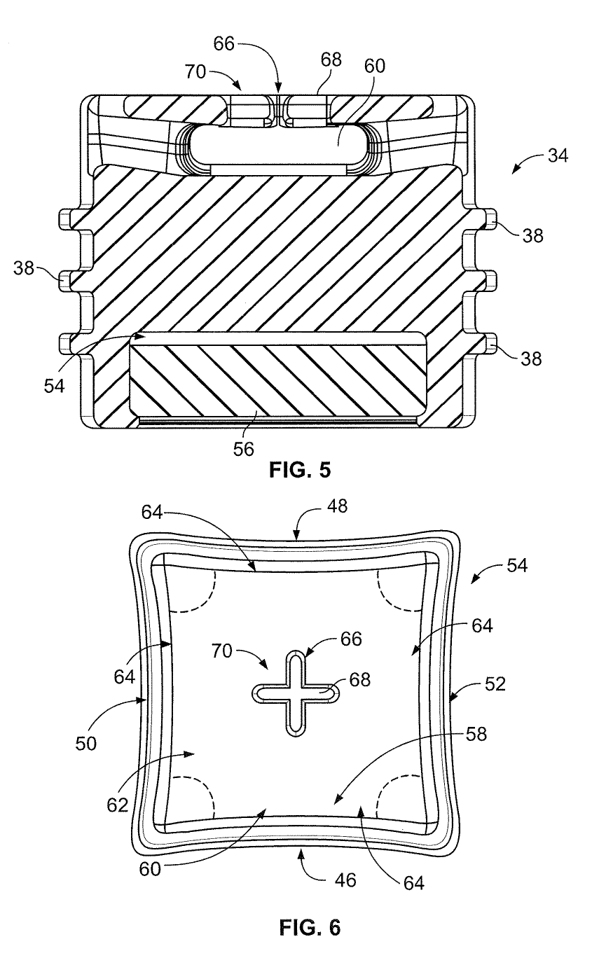

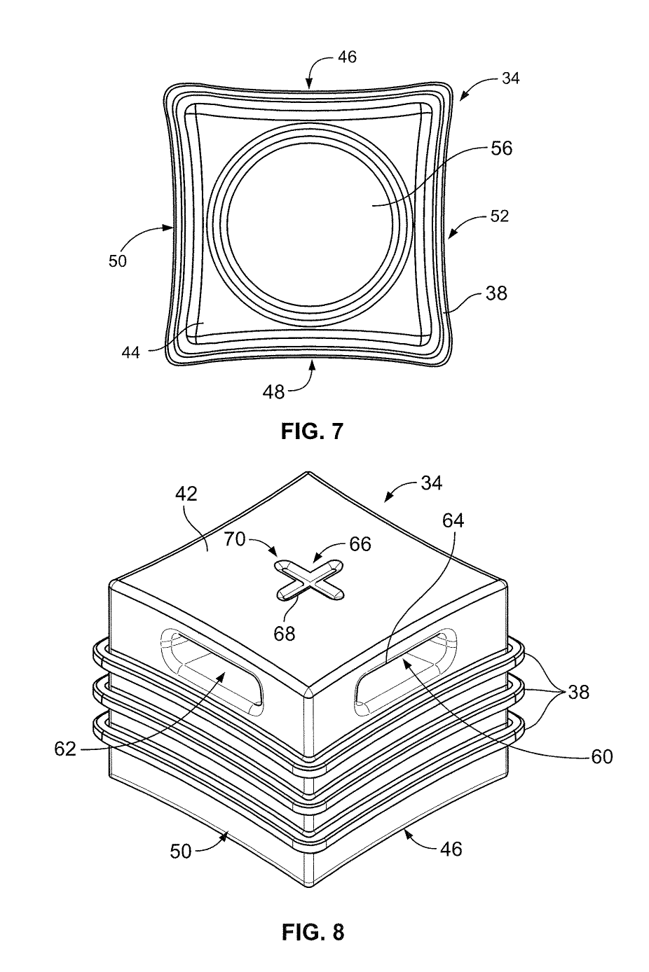

Turning to FIGS. 2-8, the disclosure is directed to a plug 34 that is sized and shaped to be received by the socket 28 of the driven element 20. The plug 34 generally includes a plug body 36 sized and shaped to fill a major portion of the volume of the socket 28. The plug body 36 may be made of a metal, for example, cast steel, a polymeric material or any suitable material with sufficient durability to endure conditions to which it is exposed in a particular operating environment. Examples of polymeric materials include high-density polyethylene (HDPE) and high molecular weight polyethylene (HMWPE).

The plug body 36 may be similar in axial length to depth of the socket (D) and of a shape that fits snugly within the socket 28 with a friction fit, while permitting the plug 34 to be inserted and withdrawn from the socket. It will be understood that the plug body 36 can be made of a size and shape to be accessible after being received in the socket 28.

A plurality of ribs 38 are formed radially outward from and, in the orientation shown, horizontally on the plug body 36. The ribs 38 extend from the plug body to contact walls of the socket 28 such that plug 34 fits into the socket in a snug fashion. Snug, for purposes of this application, means that the plug 34 can be inserted into the socket manually and tends to remain in place with friction alone, but can be removed from the socket manually or with a simple tool such as a lever. In other words, the fit of the plug 34 to the socket 28 is not irreversible or permanent as would occur, for example, with an interference fit, but the plug 34 is sufficiently fitted to the socket to discourage ingress of foreign material between the plug 34 and the socket 28.

The ribs 38 may be provided as three features, as shown, or alternatively as only two features. Also, the ribs 38 may be four or more features. The ribs 38 may be formed from the same material as the plug body or may be made of a different material. In one embodiment, the ribs 38 are made of a material that is deformable to conform and grip the socket 28 snugly.

The plug body 36 includes a top portion 42 and a bottom portion 44. In the illustrated embodiment, the plug 34 resides within a square drive socket of a driven element 20 and includes four side portions, which may be referred to as a front side portion 46, a backside portion 48, a left side portion 50 and a right side portion 52. The use of front, back and so on is for purposes of orientation and according to the illustrated embodiments unless otherwise specified.

The bottom portion 44 is the portion of the plug body 36 that enters the socket 28 first upon insertion of the plug body 36 into the socket 28. The bottom portion 44 includes an open chamber or recess 54 that holds a magnet 56. Alternatively, the bottom portion 44 may include a magnet 56 molded therein, which may be accomplished, for example, by injection molding of a material around the magnet. Encapsulating the magnet 56 into a molded article may have the benefit of reducing exposure of the magnet to environmental conditions. The function of the magnet 56 is to releasably attach the plug 34 in the socket 28 of the driven element 20. The magnet 56 may be cylindrical, rectangular, or any suitable shape.

As mentioned previously, the plug body 36 includes a plurality of ribs 38 formed thereabout. In other words, two or more spaced apart ribs 38 are formed on the sides 46, 48, 50 and 52 and wrap about the plug body in an uninterrupted fashion between the top and bottom portions 42, 44. The shape of the ribs 38 in cross section may be semicircular, square, rounded, angled, rectangular, or any suitable shape. It should be understood that the shape and size of the plug body 36 and ribs 38 fit the plug 34 to the size and shape of the socket 28. For example, square drives are not necessarily perfectly square. A standard for square drives specifies that the shape of the socket walls is not planar, but slightly convex. The shape and side of at least the ribs 38 should be correspondingly slightly concave to conform to the shape of the socket walls. In one embodiment, both ribs 38 and sides 46, 48, 50 and 52 are formed to correspond to the shape of the socket for which they are intended. As will be shown herein, there are many versions of drive sockets for driven elements and it will be understood that the size and shape of the ribs 38 and sides 46, 48, 50 and 52 are formed to correspond to the shape of the particular socket, whether it is square, hexagonal, octagonal, star-shaped and so on.

The top portion 42 of the plug 34 can include at least one plug removal feature 70. In one embodiment, the plug 34 includes a first passage 60 extending from the front side portion 46 to the backside portion 48 and a second passage 62 extending from the left side portion 50 to the right side portion 52. The first and second passages 60, 62 intersect in the plug body 36 in a “+” configuration to define a hollow space 58 below the top portion 42. The first and second passages 60, 62 define respective openings 64 (one on each of the sides 46, 48, 50, 52) that are sized and shaped to receive a tool, such as a flat headed screwdriver or pry lever (not shown). During removal, a tip of the tool can be inserted into the opening 64 and used to pry the plug 34 from a socket 28. Alternatively, the plug 34 may have only one passage defining two openings 64 and a tool could be inserted into the front one of the two openings or the back one of the two openings. Also, the plug 34 may have only one opening 64 in the form of a cavity and a tool could be inserted into the one opening for removing the plug 34 from a socket 28.

The top portion 42 may have also a removal feature 70 in the form of an area of weakened material 66. The area of weakened material 66 provides an area of the top portion 42 that yields to a tool, such as a screwdriver. The area of weakened material 66 permits the tool to break through the area of weakened material of the top portion and engage the plug 34 by inserting the tool into the space 58 underneath the top potion in order to pry the plug from a socket 28. The area of weakened material 66 may be provided by one or more indentations, slots 68, perforations or the like, formed through or in the top portion 42.

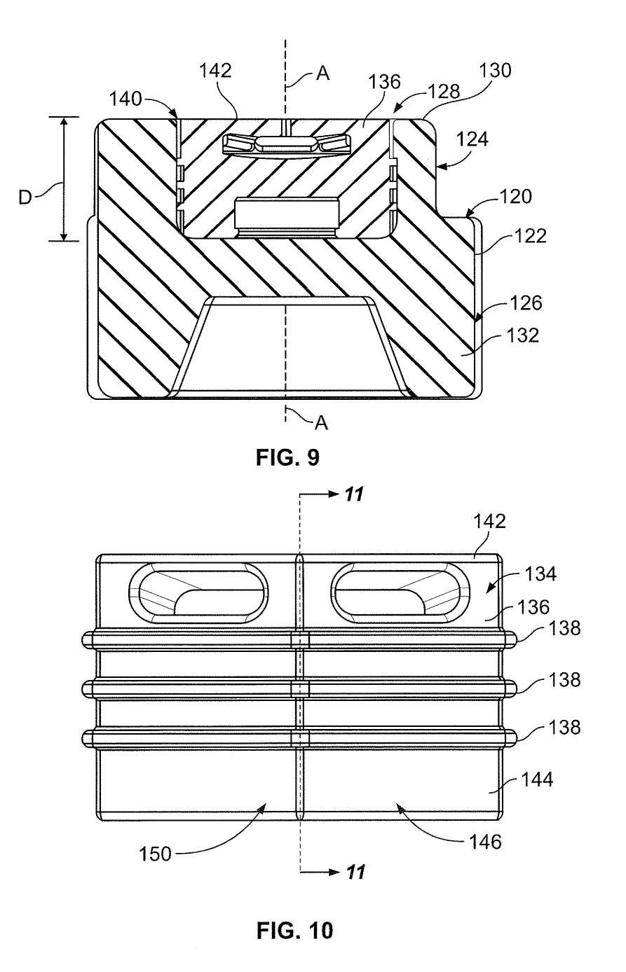

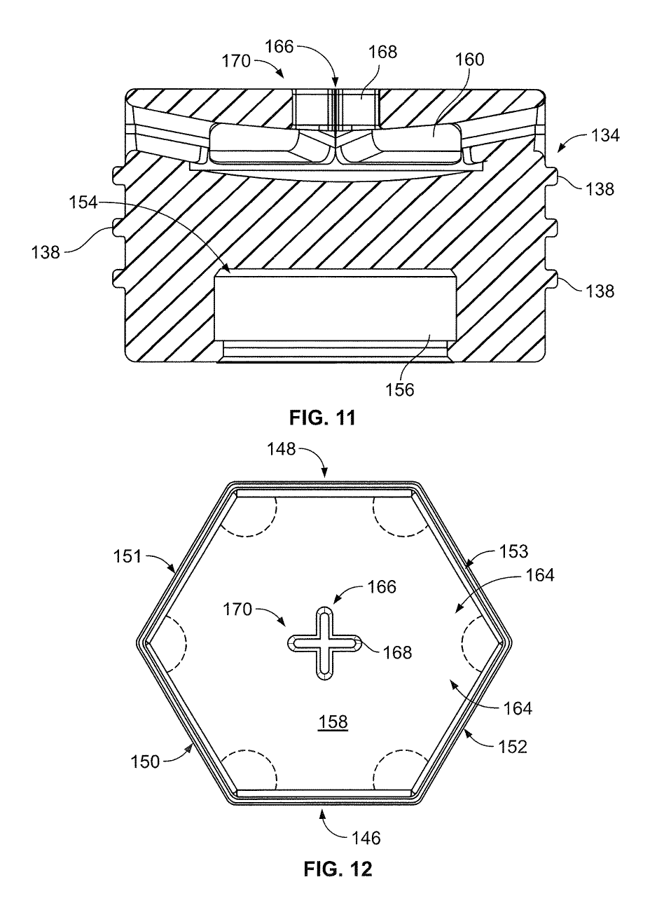

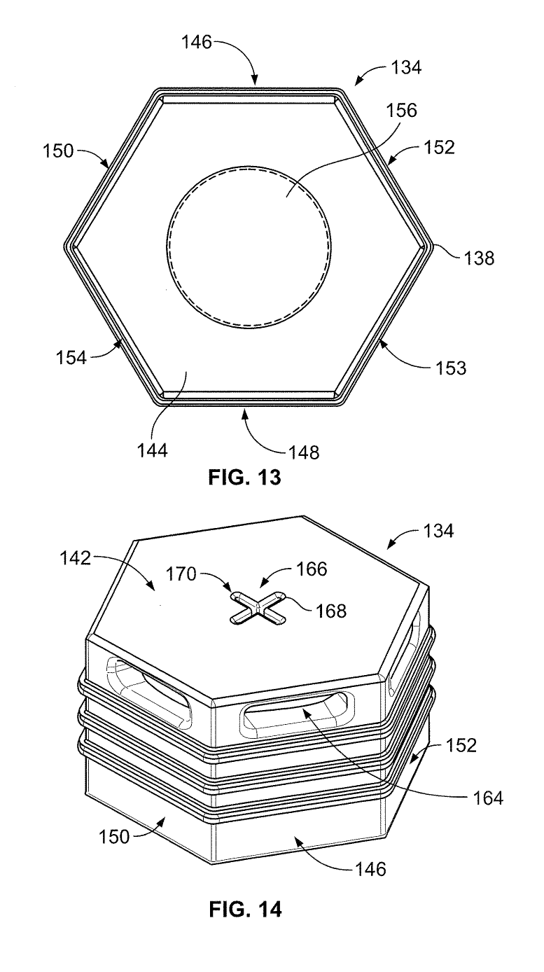

FIGS. 9-14 illustrate a plug 134 that differs from that disclosed above only in that the socket 128 of the driven element 120 is six-sided and the shape and size and features of the plug conforms to the socket. The driven element 120 shown in FIG. 9 is a type of rotatable locking element with a body 122, which can be made of metal such as cast iron or steel. The body 122 may generally include an upper portion 124 and a lower portion 126. The body 122 may also have an axis, A. The upper portion 124 includes a socket 128 formed therein, which is longitudinally aligned to axis A, and opens to the top 130 of the body. A bevel or radius 140 may be formed where the socket 128 opens to the top 130.

Generally, the body 122 may be rounded about axis A. The lower portion 126 includes a partially enclosed skirt or arcuate wall 132 like that disclosed above. The size and shape of the socket 128 may be considered to be generally hexagonal with a depth, D, that permits sufficient engagement with a corresponding square drive tool (not shown).

Turning to FIGS. 10-14, a plug 134 is sized and shaped to be received by the socket 128 of the driven element 120. The plug 134 generally includes a plug body 136 sized and shaped to fill a major portion of the volume of the socket 128. The plug body 136 may be similar in axial length to that of the socket (depth D) and of a shape that fits snugly within the socket 128.

A plurality of ribs 138 are formed radially outward from and horizontally on the plug body 136 that extend from the plug body to contact walls of the socket 128 such that plug 134 fits into the socket in a snug fashion. The ribs 138 may be provided as three features, as shown, or alternatively as two or four or more features.

The plug body 136 includes a top portion 142 and a bottom portion 144. Since this embodiment of the plug 134 is fashioned to reside within a hexagonal drive socket of a driven element 120, the plug includes six side portions. The six side portions may be referred to as a front side portion 146, a backside portion 148, a first left side portion 150 and a second left side portion 151, a first right side portion 152 and a second right side portion 153.

The bottom portion 144 includes an open chamber or recess 154 that holds a magnet 156. Alternatively, the bottom portion 144 may included a magnet 156 molded therein, which may be accomplished by injection molding, for example. The magnet 156 may be cylindrical, rectangular, or any suitable shape.

The plug body 136 includes a plurality of ribs 138 formed thereabout and have the same general shape and size as those described above and fit to the socket 128. The top portion 142 of the plug 134 includes one or more plug removal feature 170. In one embodiment, the plug 134 includes a first passage 160 extending from the front side portion 146 to the backside portion 148 and a second passage 162 extending from the first left side portion 150 to the second right side portion 153. A third passage 163 extends from the second left side portion 151 to the first right side portion 152. The passages 160, 162 and 163 intersect in the plug body 136 in a configuration to define a space 158 underneath the top portion 142. The passages 160, 162 and 163 define respective openings 164 that are sized and shaped to receive a tool, such as a flat headed screwdriver (not shown) sued to pry the plug 134 from socket 128. Alternatively, the plug 134 may have only one or more openings 164 in the form of a cavity and a tool could be inserted into the opening for removing the plug 134 from a socket 28.

The top portion 142 may have also a removal feature 170 in the form of an area of weakened material 166. The area of weakened material 166 provides an area of the top portion 142 that yields to a tool such as a screwdriver. The area of weakened material 166 permits the tool to break the area of weakened material of the top portion and engage the plug 134 by inserting the tool into the space 158 underneath the top potion in order to pry the plug from socket 128. The area of weakened material 166 may be provided by one or more slots 168 formed in the top portion 142.

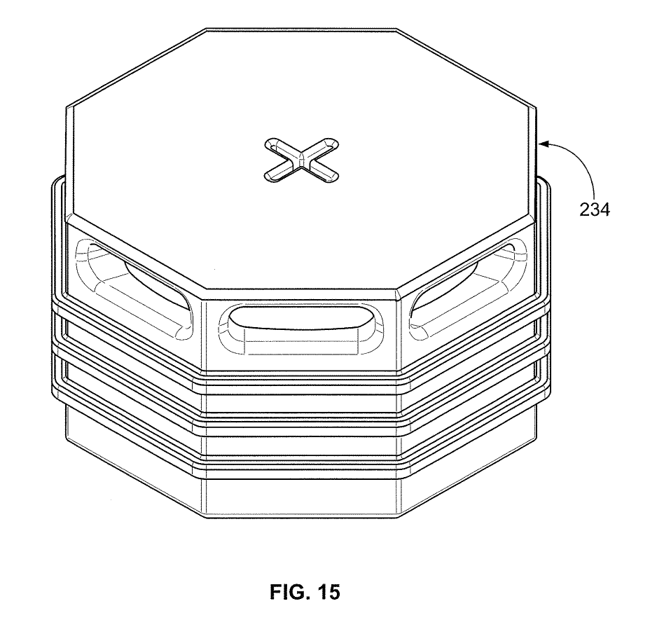

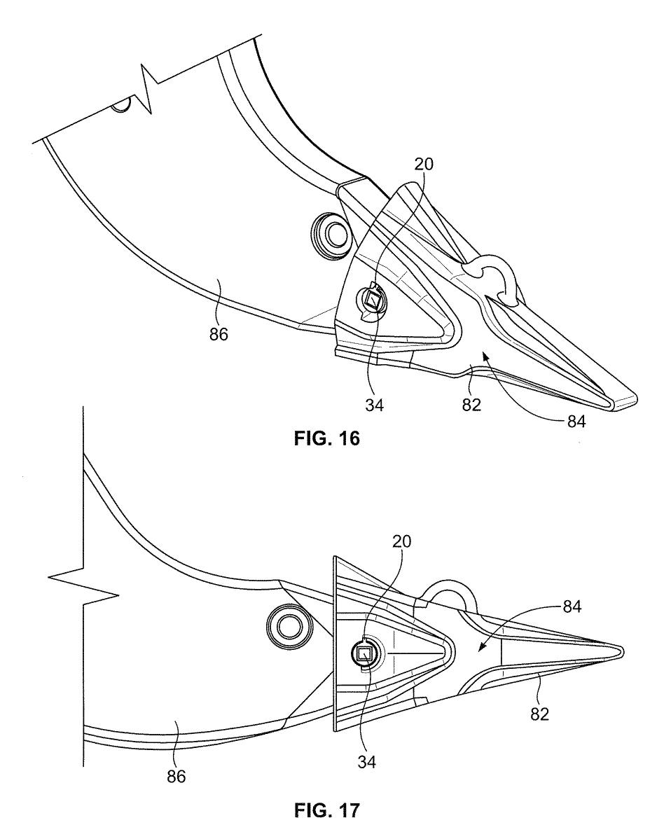

FIG. 15 illustrates yet another embodiment of a plug 234 shaped and sized to be received in a socket (not shown) with eight sides (octagonal). It will be understood that the plug 234 illustrated in FIG. 15 has the same features as the plugs 34, 134 (see above) except it is configured for a socket with eight sides.

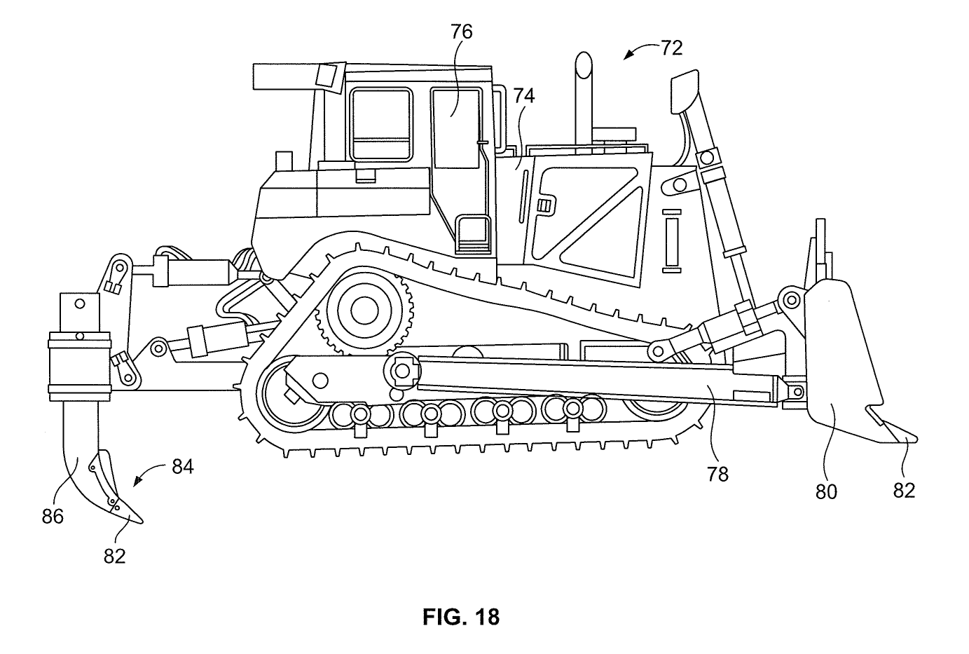

FIGS. 16 and 17 are, respectively, perspective and side views of a replaceable ground-engaging first tool assembly 84 (see also FIG. 18) in the form of a ripper 86. The first tool assembly 84 includes a replaceable ground-engaging tool 82 that includes a captive driven element 20 that is, at least in part, removably held in place by the operation of the driven element. The driven element 20 includes a plug 34 that is removably positioned in the driven element according to the above disclosure. To replace the ground-engaging tool 82, the plug 34 is removed from the driven element 20. The driven element 20 is engaged with an appropriate tool, such as the male part of a square drive socket wrench (not shown), and rotated as is well known. Rotating the driven element 20 permits the ground-engaging tool 82 to be removed from the base of the ripper 86 as is well known.

FIG. 18 is a machine 72 that includes a machine frame 74 with a cab 76 to house a machine operator. The machine 72 may also include an arm system 78 pivotally connected at one end to the machine frame 74 or undercarriage and supporting an implement, such as an earth-working blade, bucket, or any other type of suitable device that is optionally provided with a second tool assembly 80 with a replaceable ground-engaging tool 82 at an opposing, distal end. The illustrated machine 72 also may include the first tool assembly 84 having a ripper 86 opposite the second tool assembly 80. The ripper 86 can be used to cut through and break up working material for removal. A control system (not shown) can be housed in the cab 76 that can be adapted to allow a machine operator to manipulate and articulate the implement and second tool assembly 80 and/or the first tool assembly 84 for digging, excavating, or any other suitable application. The first tool assembly 84 and second tool assembly 80 may both be provided with a replaceable ground-engaging tool 82 held in place, at least in part, by a driven element 20 that incorporates a plug 34 according to the disclosure.

Although FIG. 18 illustrates the use of a plug installed within a driven element constructed in accordance with principles of the present disclosure to retain a ground engaging tool for a ripper of a track-type tractor, many other types of implements and mining and construction machinery can benefit from using the plug as described herein. It should be understood that, in other embodiments, a plug constructed in accordance with principles of the present disclosure might be used in a variety of other implements and/or machines.

### INDUSTRIAL APPLICABILITY

The industrial application of a plug installed into a driven element has the purpose of maintaining a tool-engaging socket of the driven element in an engageable state. In other words, the plug resists or avoids the tendency for the sockets of driven elements to become fouled or packed with foreign material. One reason the removable plugs according to the present disclosure are beneficial is that the replacement of parts or maintenance of machinery and so on can be performed quickly and easily if the driven elements, such as locks, fasteners and the like are easily accessed and operated. Plugs according to the present disclosure are quickly and easily installed and are just as easily removed. Thus, the driven elements are quickly and easily engaged. The present disclosure can be applicable to many different machines and environments.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A magnetic plug for excluding foreign material from the drive socket of a driven element, comprising:
a plug body having a top portion, a bottom portion, and a plurality of side portions extending between the top portion and the bottom portion, the plug body being sized and shaped to be received within the drive socket;
a plurality of ribs disposed on the plurality of side portions of the plug body, the plurality of ribs sized and shaped to be removably received in the drive socket and exclude the intrusion of foreign material into the drive socket; and
at least one removal feature formed at or near the top portion.

2. The magnetic plug of claim 1, wherein the plurality of ribs includes three separate and spaced horizontal ribs that fully encircle the plug body and extend from the plurality of side portions to provide a snug fit within the drive socket.

3. The magnetic plug of claim 1, wherein the at least one removal feature is at least one cavity formed in one or more of the plurality of side portions and adjacent the top portion, the at least one cavity sized and shaped to receive a tool to permit removal of the plug from the drive socket.

4. The magnetic plug of claim 1, wherein the at least one removal feature includes an opening formed through the plug body and adjacent the top portion, the opening sized and shaped to receive a tool to permit removal of the plug from the drive socket.

5. The magnetic plug of claim 4, wherein the at least one removal feature is two or more openings formed through the plug body and adjacent the top portion.

6. The magnetic plug of claim 5, wherein the two or more openings form a space in the plug body adjacent the top portion.

7. The magnetic plug of claim 6, wherein the at least one removal feature further comprises an area of weakened material formed in the top portion through which a tool can be inserted and which will permit engagement with the tool and removal of the plug from the drive socket.

8. The magnetic plug of claim 1, wherein a magnet is disposed in a recess formed in the bottom portion of the plug body.

9. The magnetic plug of claim 8, wherein the plug body is made of metal or a polymeric material.

10. The magnetic plug of claim 1, wherein the plug body is four-sided and shaped and sized to be received in a square drive socket.

11. A tool assembly removably mountable to a machine, comprising:
a replaceable ground-engaging tool;
a driven element for removably securing the ground-engaging tool to the machine, the driven element having a drive socket; and
a magnetic plug disposed in the drive socket of the driven element, the plug comprising;
a plug body having a top portion, a bottom portion, and a plurality of side portions extending between the top portion and the bottom portion, the plug body being sized and shaped to be received within the drive socket;
a plurality of ribs disposed on the plurality of side portions of the plug body, the plurality of ribs sized and shaped to be removably received in the drive socket and exclude the intrusion of foreign material into the drive socket; and
at least one removal feature formed at or near the top portion.

12. The tool assembly of claim 11, wherein the plurality of ribs includes three separate and spaced horizontal ribs that fully encircle the plug body and extend from the plurality of side portions to provide a snug fit within the drive socket.

13. The tool assembly of claim 11, wherein the at least one removal feature is at least one cavity formed in one or more of the plurality of side portions and adjacent the top portion, the at least one cavity sized and shaped to receive a tool to permit removal of the plug from the drive socket.

14. The tool assembly of claim 11, wherein the at least one removal feature includes an opening formed through the plug body and adjacent the top portion, the opening sized and shaped to receive a tool to permit removal of the plug from the drive socket.

15. The tool assembly of claim 14, wherein the at least one removal feature is two or more openings formed through the plug body and adjacent the top portion.

16. The tool assembly of claim 15, wherein the two or more openings form a space in the plug body adjacent the top portion.

17. The tool assembly of claim 16, wherein the at least one removal feature further comprises an area of weakened material formed in the top portion through which a tool can be inserted and which will permit engagement with the tool and removal of the plug from the drive socket.

18. The tool assembly of claim 11, wherein a magnet is disposed in a recess formed in the bottom portion of the plug body.

19. The tool assembly of claim 11, wherein the driven element is held captive to the ground-engaging tool.

20. A method of mitigating packing of foreign material in a drive socket of a driven element, comprising:
providing the drive socket in a selected size and shape;
providing a plug with a size and shape to conform to the selected size and shape of the drive socket;
removably fitting the plug in the drive socket; and
retaining the plug in the drive socket magnetically and via a friction fit.
